(19) United States
(12) Patent Application Publication
(10) Pub. No.: US 2025/0190923 A1
(43) Pub. Date: Jun. 12, 2025

(54) BLOCKCHAIN-BASED TOKENIZED ERP INCENTIVE SYSTEM

(71) Applicants: Srujan Reddy Anugu, Mason, OH (US); Durga Rao Manchikanti, South Jordan, UT (US); Hanumantha Rao Kavuri, Herriman, UT (US); Nishanth Vepachedu, Holladay, UT (US)

(72) Inventors: Srujan Reddy Anugu, Mason, OH (US); Durga Rao Manchikanti, South Jordan, UT (US); Hanumantha Rao Kavuri, Herriman, UT (US); Nishanth Vepachedu, Holladay, UT (US)

(21) Appl. No.: 19/055,554

(22) Filed: Feb. 18, 2025

(51) Int. Cl. G06Q 10/0639; H04L 9/00

(52) U.S. Cl. CPC G06Q 10/06398; H04L 9/50; H04L 2209/56

(57) ABSTRACT

The “Blockchain-Based Tokenized ERP Incentive System” integrates several novel features that leverage advanced technology to enhance the functionality and effectiveness of Enterprise Resource Planning (ERP) systems. The Blockchain-Based Tokenized ERP Incentive System transforms enterprise incentive management through automation, security, and transparency. By integrating blockchain with ERP systems, it creates a scalable, fair, and efficient solution for rewarding performance while promoting sustainability.

### TECHNICAL FIELD

The present invention relates to Enterprise Resource Planning (ERP) systems and, more specifically, to an integrated blockchain-based incentive system that tokenizes and automates the distribution of rewards based on performance metrics.

### BACKGROUND OF THE INVENTION

Traditional ERP systems manage and optimize business processes, but they often lack an efficient, transparent, and automated incentive mechanism. Current incentive structures are typically manual, prone to human bias, and lack real-time integration with enterprise performance data. Blockchain technology offers a decentralized and immutable ledger, making it an ideal solution for tracking and distributing performance-based incentives.

### BRIEF SUMMARY OF THE INVENTION

The “Blockchain-Based Tokenized ERP Incentive System” integrates blockchain technology into Enterprise Resource Planning (ERP) systems to revolutionize how incentives are managed and distributed across organizations. This innovative system introduces a tokenized reward mechanism that assigns digital tokens to employees, vendors, and stakeholders based on their performance and contributions. The primary goal is to enhance transparency, security, and efficiency in tracking and rewarding enterprise activities.

The present invention provides a blockchain-based tokenized ERP incentive system that includes:

1. A token allocation system configured to allocate digital tokens to users based on performance metrics recorded in an ERP system, where the allocation is governed by smart contracts.

2. A smart contract implementation method for creating, deploying, and executing smart contracts on a blockchain to automatically distribute rewards in the form of digital tokens based on predefined performance criteria.

3. A blockchain ledger system for recording both the performance metrics that determine token allocations and the subsequent token transactions, ensuring that all entries are immutable and transparent.

4. A system for integrating blockchain technology with existing ERP software from major vendors (such as SAP, Oracle, and Microsoft Dynamics) to dynamically utilize real-time data for token-based incentive schemes.

5. A method for integrating and processing real-time performance data from ERP systems to update token allocations dynamically, based on current performance indicators.

6. A digital wallet system configured to securely store and manage the digital tokens earned by users, providing functionalities for viewing balances, redeeming tokens, and tracking transaction histories.

7. A reward redemption module that allows users to redeem their earned tokens for various rewards, where the redemption process is governed by smart contracts to ensure the accuracy and fairness of transactions.

8. An AI-powered gamification system that designs and updates the smart contracts for token allocation based on gamification rules, which are adjusted according to the evolving performance metrics and organizational goals.

9. A method for linking token rewards to sustainability and environmental, social, and governance (ESG) goals, thereby incentivizing participants to contribute towards organizational sustainability initiatives.

10. Security mechanisms implemented within the blockchain and digital wallet systems to ensure data privacy and protect against unauthorized access and fraud.

### BRIEF DESCRIPTION OF THE DRAWINGS

Other objects and advantages of the present invention will become apparent to those skilled in the art upon reading the following detailed description of the preferred embodiments, in conjunction with the accompanying drawings, wherein like reference numerals have been used to designate like elements, and wherein:

FIG. 1 illustrates system architecture according to one embodiment of the invention.

The drawings described herein are for illustration purposes only and are not intended to limit the scope of the present invention in any way.

### DETAILED DESCRIPTION OF THE INVENTION

It is to be understood that the present disclosure is not limited in its application to the details of construction and the arrangement of components set forth in the following description or illustrated in the drawings. The present disclosure is capable of other embodiments and of being practiced or of being carried out in various ways. In addition, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

The “Blockchain-Based Tokenized ERP Incentive System” integrates several novel features that leverage advanced technology to enhance the functionality and effectiveness of Enterprise Resource Planning (ERP) systems.

According to one embodiment of the invention, the following are key features of the present invention:

Tokenized Performance-Based Incentives: The system awards blockchain-based tokens for meeting specific performance benchmarks. This method of incentivization is more transparent and immutable compared to traditional incentive systems. By tokenizing incentives, the system ensures a verifiable and secure way to recognize and reward contributions, which can be particularly transformative in large organizations where tracking performance and contributions can be complex.

Smart Contract-Driven Gamification: Utilizes smart contracts to automatically trigger rewards based on achievements tied to Key Performance Indicators (KPIs). This feature automates the incentive process, reducing the need for manual intervention and making the distribution of rewards more efficient and impartial.

Blockchain-Backed Reward and Performance Metrics Distribution: Ensures that both the distribution of tokens and the performance metrics that determine those distributions are recorded immutably on a decentralized ledger. Enhances transparency and trust among participants by providing a tamper-proof system where both the criteria for rewards and the rewards themselves are verifiable.

Real-Time Performance Metrics Integration: Incorporates real-time data integration from various ERP systems to assess and update performance metrics continuously. Allows for dynamic adjustment of incentives based on real-time organizational performance, aligning incentives more closely with current business goals and operations.

Interoperability with Existing ERP Modules: Seamlessly integrates with major ERP platforms like SAP, Oracle, and Microsoft Dynamics without disrupting existing workflows. Provides flexibility and scalability, making it easy to adopt in diverse IT environments and extending its utility across different industries.

Sustainability & ESG Alignment: Links token rewards to environmental, social, and governance (ESG) goals, such as carbon credit achievements or other sustainability metrics. Encourages and incentivizes sustainable practices within organizations, aligning employee and vendor actions with broader corporate responsibility goals

These novel features collectively make the system not only a tool for improving efficiency and transparency in incentive management but also a platform for promoting sustainability and ethical governance within organizations. Each feature builds on the capabilities of blockchain technology to address specific challenges in traditional ERP and incentive systems, making this invention a significant advancement in the field of enterprise resource management.

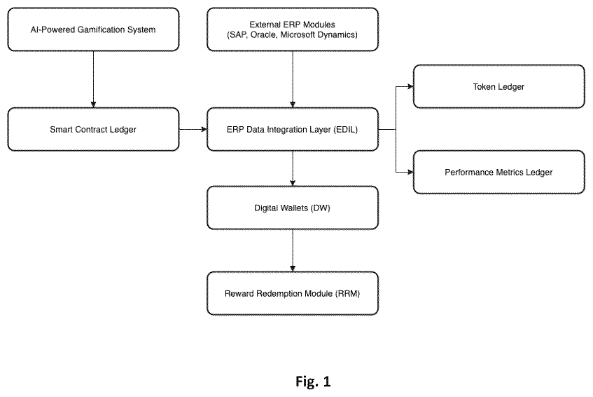

FIG. 1 illustrates system architecture according to one embodiment of the invention. As shown in FIG. 1, the flow essentially starts from the creation and storage of rules in the form of smart contracts by the AI-Powered Gamification System. These rules are then applied to the performance data that is integrated from ERP systems and stored in the Performance Metrics Ledger. Based on these metrics, tokens are allocated and recorded in the Token Ledger, managed in Digital Wallets, and finally, converted into rewards through the Reward Redemption Module.

Advantages of the present invention: The “Blockchain-Based Tokenized ERP Incentive System” introduces several key advantages that significantly enhance the operational efficiency and ethical standards of an organization's incentive management practices. Here are the detailed benefits of this innovative system:

1. Enhanced Transparency and Trust: The blockchain ledger provides an immutable record of all transactions and performance metrics. This transparency ensures that every stakeholder can trust the fairness and accuracy of the reward distribution process. It minimizes disputes over rewards and enhances the credibility of the incentive system.

2. Increased Motivation and Engagement: By tokenizing incentives, the system offers a clear and direct reward mechanism that is closely tied to specific achievements and performance benchmarks. This clarity and immediacy can significantly boost motivation among employees and vendors, encouraging higher performance and greater engagement with organizational goals.

3. Automated Reward Distribution: The use of smart contracts automates the entire process of reward calculation and distribution. This automation reduces the administrative burden associated with manual reward systems and eliminates human errors and bias, ensuring that rewards are distributed efficiently and equitably.

4. Real-Time Performance Tracking: Integration with ERP systems allows the incentive system to utilize real-time performance data. This capability enables the organization to dynamically adjust incentives based on current data, aligning rewards more closely with the immediate needs and objectives of the business.

5. Reduced Administrative Overhead: Automating the reward distribution process not only increases its efficiency but also significantly reduces the resources and time required for administrative management of incentive programs. This reduction in overhead can result in considerable cost savings for the organization.

6. Support for Sustainability and Corporate Social Responsibility: The system's ability to link rewards to sustainability goals and ESG (Environmental, Social, and Governance) criteria helps promote environmentally friendly and socially responsible behaviors. This alignment can enhance the organization's reputation and compliance with regulatory standards for corporate responsibility.

7. Enhanced Data Security and Privacy: The use of blockchain technology ensures high levels of security and privacy for stored data. Blockchain's inherent characteristics such as decentralization and encryption provide robust protection against data breaches and unauthorized access.

8. Scalability and Flexibility: The system is designed to be scalable and can be integrated with various ERP platforms. This flexibility ensures that it can be adapted to the specific needs of different organizations, regardless of size or industry, and can grow with the organization over time.

9. Incentivization of Desired Behaviors: By carefully designing the gamification and reward aspects of the system, organizations can strategically incentivize behaviors that align with their broader strategic objectives, such as innovation, efficiency, customer satisfaction, or quality improvements.

10. Legal and Regulatory Compliance: Immutable record-keeping and the transparent nature of blockchain transactions can help organizations comply with legal and regulatory requirements related to financial and operational accountability.

These advantages make the “Blockchain-Based Tokenized ERP Incentive System” not just a tool for improving the efficiency and fairness of incentive distributions, but also a strategic asset that can drive organizational change, foster a culture of performance and responsibility, and enhance the overall value of the enterprise.

It will be recognized that the above described subject matter may be embodied in other specific forms without departing from the scope or essential characteristics of the disclosure. Thus, it is understood that, the subject matter is not to be limited by the foregoing illustrative details, but it is rather to be defined by the appended claims.

While specific embodiments of the invention have been shown and described in detail to illustrate the novel and inventive features of the invention, it is understood that the invention may be embodied otherwise without departing from such principles.

What is claimed is:

1. A blockchain-based tokenized enterprise resource planning (ERP) incentive system, the system comprising:
a. a token allocation system configured to allocate digital tokens to users based on performance metrics recorded in an ERP system, where the allocation is governed by smart contracts.
b. a smart contract implementation method for creating, deploying, and executing smart contracts on a blockchain to automatically distribute rewards in the form of digital tokens based on predefined performance criteria.
c. a blockchain ledger system for recording both the performance metrics that determine token allocations and the subsequent token transactions, ensuring that all entries are immutable and transparent.

2. The system as claimed in claim 1, wherein the token allocation system is integrated with an existing ERP system to dynamically utilize real-time data for token-based incentive schemes.

3. The system as claimed in claim 1, wherein the smart contract implementation method uses a decentralized blockchain platform to ensure the security and transparency of the reward distribution process.

4. The system as claimed in claim 1, wherein the blockchain ledger system is configured to record both the performance metrics and the subsequent token transactions, ensuring that all entries are immutable and transparent.

5. The system as claimed in claim 1, wherein the blockchain ledger system comprises a method for utilizing smart contracts to automate token distribution based on predefined criteria.

6. The system as claimed in claim 1, wherein the blockchain ledger system is for recording performance metrics and transactions immutably.

7. The system as claimed in claim 1, wherein the blockchain ledger system contains ERP software to dynamically adjust token distribution and real-time processing of performance data for incentive allocation.

8. The system as claimed in claim 1, wherein the blockchain ledger system contains security mechanism ensuring data privacy and frand prevention within the blockchain network.
